(19) United States
(12) Patent Application Publication
(10) Pub. No.: US 2019/0213974 A1
(43) Pub. Date: Jul. 11, 2019

(54) Color Matching for Output Devices

(71) Applicant: Apple Inc., Cupertino, CA (US)

(72) Inventors: Gabriel Marcu, San Jose, CA (US); Ian C. Hendry, San Jose, CA (US)

(21) Appl. No.: 15/868,552

(22) Filed: Jan. 11, 2018

(51) Int. Cl. G09G 5/06

(52) U.S. Cl. CPC G09G 5/06; G06F 3/0482; G09G 2354/00; G09G 2320/0666

(57) ABSTRACT

Systems, methods, and computer readable media to perform color matching between a source color profile and a user-selected color profile are described. Various embodiments receive user input to select a color profile to output source content to an output device, where the source content is associated with a source color profile. Various embodiments set the selected color profile as a target color profile and subsequently perform a first device-dependent color space conversion that converts the source color profile to the target color profile and uses the conversion to generate a target content from the source content. A second device-dependent color space conversion can then be performed to convert the target color profile to a device color profile and uses the conversion to generate output device content from the target content.

### BACKGROUND

This disclosure relates generally to color matching for output devices. More particularly, but not by way of limitation, this disclosure relates to reproducing color on a display device that matches a user's expectation and/or a designated color scheme.

Consistently reproducing color on a variety of different electronic devices, such as printers, monitors, televisions, scanners, and/or mobile devices, can impact a user's experience with digital content that contain color text, photographs, and/or videos. For instance, accurately reproducing color on a display device's screen allows a user to perform corrective actions and modifications that can be seen when the digital content is printed out. However, different output devices often have color spaces with varying gamut ranges because of the different capabilities of the devices. As an example, a monitor can be configured with a specific red, green, and blue (RGB) color space that differs from a printer's cyan, magenta, yellow, and black (CMYK) color space. In order to consistently reproduce colors across different devices, an output device can utilize a color management system that performs color matching operations, such as mapping colors between the output devices with different gamut ranges and transforming colors from one device-dependent color space to another.

A color management system may allow a user to select a color profile for a display device (e.g., International Color Consortium (ICC) profile) and subsequently reproduce colors for the digital content based on the selected color profile. However, in certain instances, a user may select a color profile that is incompatible with the display settings of a display device. The mismatch in the user-selected color profile and display settings may cause distortions when displaying the digital content. For example, when a user selects a standard RGB color profile, but the display device is configured with a Digital Cinema Initiatives (DCI)-P3 gamut, the display device may distort colors depending on the mismatch between the display device settings and the selected color profile. To prevent color mismatch and distortions, the color management system may provide a color profile matching option (e.g., a checkbox that shows only profiles relevant for a given display device) that removes and filters out color profiles incompatible with the settings of the display device. Unfortunately, a user may override or disable the color profile matching option and incidentally select an incompatible color profile. As a result, being able to color match from one device-dependent color space to another without generating relatively high amounts of color distortions remains valuable for color correction-based technologies.

### Summary

In one embodiment, the disclosure provides a method to color map based on a user-selected color profile. The method obtains a source content associated with a source color profile that maps a first set of color values to a first color space and receives instructions to select a color profile for an output device. Afterwards, the method sets the selected color profile as a target color profile, where the target color profile maps a second set of color values to a second color space. The method then performs a first device-dependent color space conversion that converts the source color profile to the target color profile and uses the conversion to generate the target content from the source content. The method then performs a second device-dependent color space conversion that converts the target color profile to a device color profile to generate an output device content from the target content such that the device color profile maps a third set of color values to a third color space.

In one embodiment, each of the above described methods, and variation thereof, may be implemented as a series of computer executable instructions. Such instructions may use any one or more convenient programming language. Such instructions may be collected into engines and/or programs and stored in any media that is readable and executable by a computer system or other programmable control device.

### BRIEF DESCRIPTION OF THE DRAWINGS

While certain embodiments will be described in connection with the illustrative embodiments shown herein, the invention is not limited to those embodiments. On the contrary, all alternatives, modifications, and equivalents are included within the spirit and scope of the invention as defined by the claims. In the drawings, which are not to scale, the same reference numerals are used throughout the description and in the drawing figures for components and elements having the same structure, and primed reference numerals are used for components and elements having a similar function and construction to those components and elements having the same unprimed reference numerals.

FIG. 1 is a diagram of a communication system where embodiments of the present disclosure may operate.

FIG. 2 is a block diagram of an embodiment of a computing system architecture adapted to perform color matching based on a user-selected color profile for a display device.

FIG. 3 is a block diagram of an embodiment of a computing system architecture adapted to perform color matching operations within a computing system.

FIG. 4 illustrates an embodiment of a color matching architecture that a color management system may perform to color match a source color profile to a device color profile.

FIG. 5 illustrates a user interface for adjusting a target color profile that represents a user's preference for the behavior of an output device.

FIG. 6 illustrates an embodiment of color matching architecture that color matches a source color profile to multiple device color profiles.

FIG. 7 depicts a flowchart illustrating an operation for performing color matching between a source color profile and a user-selected color profile.

FIG. 8 is a simplified functional block diagram of an illustrative multi-functional electronic device.

### DETAILED DESCRIPTION

This disclosure includes various example embodiments that perform color matching based on a user-selected color profile. To minimize color distortions, a color management system is able to utilize a target color profile to color match a source color profile associated with source content to a user-selected color profile. When configuring and/or adjusting the settings of a display device, a user may be able to select a color profile for the display device. Once a user makes a selection, rather than assigning the user-selected color profile as the device color profile, the color management system assigns the user-selected color profile to a target color profile. For a given source content (e.g., a digital image), the color management system performs a device-dependent color space conversion of the source color profile to the target color profile. Afterwards, the color management system performs another device-dependent color space conversion of the target color profile to a device color profile. The color matching between the target color profile to the device color profile allows the colors for source content to be displayed correctly on the display screen (e.g., avoids color mismatching) even when a user selects a color profile that fails to properly fit the settings of the display device. Each of the different color profiles (e.g., source color profile) can correspond with a particular device-dependent color space that include, but are not limited to, the RGB color space or CMYK color spaces.

In the following description, for purposes of explanation, numerous specific details are set forth in order to provide a thorough understanding of the inventive concept. As part of this description, some of this disclosure's drawings represent structures and devices in block diagram form in order to avoid obscuring the invention. In the interest of clarity, not all features of an actual implementation are described. Moreover, the language used in this disclosure has been principally selected for readability and instructional purposes, and may not have been selected to delineate or circumscribe the inventive subject matter, resort to the claims being necessary to determine such inventive subject matter. Reference in this disclosure to “one embodiment” or to “an embodiment” means that a particular feature, structure, or characteristic described in connection with the embodiment is included in at least one embodiment of the invention, and multiple references to “one embodiment” or “an embodiment” should not be understood as necessarily all referring to the same embodiment.

It will be appreciated that in the development of any actual implementation (as in any development project), numerous decisions must be made to achieve the developers' specific goals (e.g., compliance with system- and business-related constraints), and that these goals may vary from one implementation to another. It will also be appreciated that such development efforts might be complex and time-consuming, but would nevertheless be a routine undertaking for those of ordinary skill in the design and implementation of detecting motion having the benefit of this disclosure.

The terms “a,” “an,” and “the” are not intended to refer to a singular entity unless explicitly so defined, but include the general class of which a specific example may be used for illustration. The use of the terms “a” or “an” may therefore mean any number that is at least one, including “one,” “one or more,” “at least one,” and “one or more than one.” The term “or” means any of the alternatives and any combination of the alternatives, including all of the alternatives, unless the alternatives are explicitly indicated as mutually exclusive. The phrase “at least one of” when combined with a list of items, means a single item from the list or any combination of items in the list. The phrase does not require all of the listed items unless explicitly so defined.

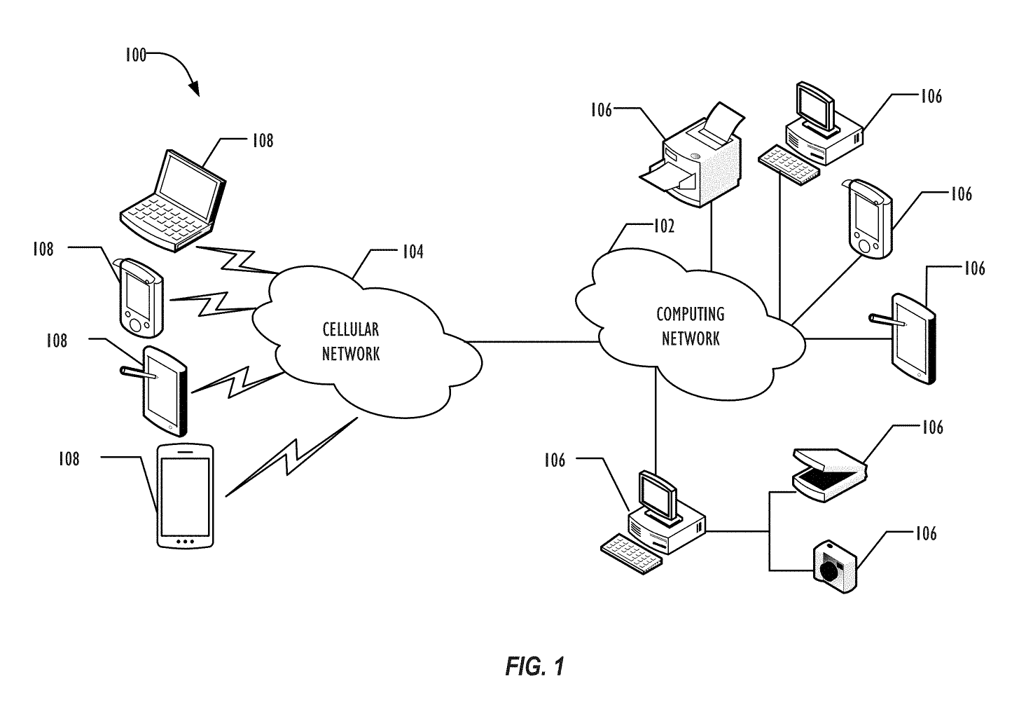

FIG. 1 is a diagram of a communication system 100 where embodiments of the present disclosure may operate. FIG. 1 illustrates that the communication system 100 may include a computing network 102 and a cellular network 104 that transports media and/or digital content that contain colored text, images, and/or videos. The computing network 102 may itself include one or more networks that transport data using one or more communication protocols. For example, computing network 102 may include the Internet, enterprise networks, data centers, wide area networks (WANs), radio-based networks (e.g., wireless fidelity (WiFi® (WiFi is a registered trademark owned by Wi-Fi Alliance Corporation)) and Bluetooth® networks (Bluetooth is a registered trademark owned by Bluetooth Sig, Inc.)), and/or local area networks (LANs). Networks within computing network 102 may route data using network protocols that include, but are not limited to, the Internet Protocol (IP), Transmission Control Protocol (TCP), and Ethernet. Computing network 102 may include a variety of computing devices 106, such as computers, printers, scanners, digital cameras, laptops, mobile devices, electronic user devices, and/or any other types of computing devices capable of capturing, displaying, and/or reproducing colored text, images, and/or videos and communicating the media and/or digital content within computing network 102.

As shown in FIG. 1, the communication system 100 may also include a cellular network 104 that is coupled to the computing network 102. The cellular network 104 may be configured to transport data and provide communication services to multiple mobile communication devices 108 that include, but are not limited to, computers, laptops, mobile devices, and/or other electronic devices that are capable of capturing, displaying, and/or reproducing colored text, images, and/or videos and communicating the media and/or digital content over a mobile communication network. Generally, the cellular network 104 is capable of supporting communication between two or more mobile communication devices 108 without the devices being physically connected (e.g., wired connection). The cellular networks 104 may also include multiple cellular towers and base stations (not shown in FIG. 1) that provide communication services and transport data between mobile communication devices 108 and/or computing devices 106.

In one or more embodiments, one or more of the computing devices 106 and/or one or more of the mobile communication devices 108 include a color management system that assigns color profiles that are accessible to a user as a target color profile. Each computing device 106 or mobile communication device 108 may contain and/or is connected to an output device (e.g., display device) that is associated with a hidden or user-inaccessible device color profile. Once the user selects or updates the color profile for a specified output device, the color management system sets the user-selected color profile as a target color profile. In certain instances, the source color profile associated with the source content may have a different gamut range than the target color profile. To correctly output the source content according to the user-selected color profile, the color management system may first match the colors of the source color profile to the target color profile. Afterwards, the color management system may use the resulting target content and perform a color match between the target color profile and the device color profile. The output device connected to or embedded within the computing devices 106 and/or mobile communication devices 108 may then output the converted source content with the device color profile. The term “source content,” used throughout this disclosure, refers to media and/or digital content with colored text, images, and/or videos.

The color matching operations described herein may involve performing several color space conversions according to multiple device-dependent color profiles. The first device-dependent color space conversion occurs when the color management system converts the source color profile to the target color profile. For example, as part of the first device-dependent color space conversion, the color management system may perform a first translation operation that converts the source color profile to a device-independent color space (e.g., a generic profile connection space). A second translation operation then converts the device-independent color space to the target color profile. If the color management system implements a single device-dependent color space conversion that directly applies the target color profile to the output device settings, the output device may reproduce color distortions and/or other types of color mismatches if the target color profile is incompatible with the output device's settings. To avoid this, a color management system in accordance with this disclosure implements a second device-dependent color space conversion to convert the target color profile to the device color profile. Because the device color profile is synchronized to match and maintain compatibility with the output device's settings, the color management system is able to reduce color mismatches and/or distortions caused when a user-selected color profile does not exactly match the output device's settings.

In one or more embodiments, the device color profile is a fixed profile that matches a specific calibration setting (e.g., factory calibration) for an output device, such as a display device. When a user modifies or adjusts a color profile (e.g., with a user interface), the color management system sets the adjusted color profile as the target color profile. Because the device color profile is a fixed color profile that is compatible with the output device's settings, the output device is able to reproduce colors that better matches a user's expectation and/or designated color schemes regardless of what the user selects as the color profile. In other words, the color management system is able to avoid color distortions and/or errors caused by random user-selected color profiles since a user's selection adjusts the target color profile, not the device color profile.

Although FIG. 1 illustrates a specific embodiment of a communication system 100, the disclosure is not limited to the specific embodiment illustrated in FIG. 1. For instance, rather than having the color management system implemented within a single computing device (e.g., desktop or laptop computer system), embodiments of the present disclosure may have the color management system located on separate devices. For example, one device may render the user interface for selecting the color profile (e.g., laptop) and another device (e.g., television or monitor) may perform the color space conversions based on the target color profile and the device color profile. Additionally or alternatively, the color management system may be found within other electronic devices that are not limited to connecting to or including a display device. As an example, the color management system may be found within electronic devices that connect to or include other types of output devices, such as a printer. The use and discussion of FIG. 1 is only an example to facilitate ease of description and explanation.

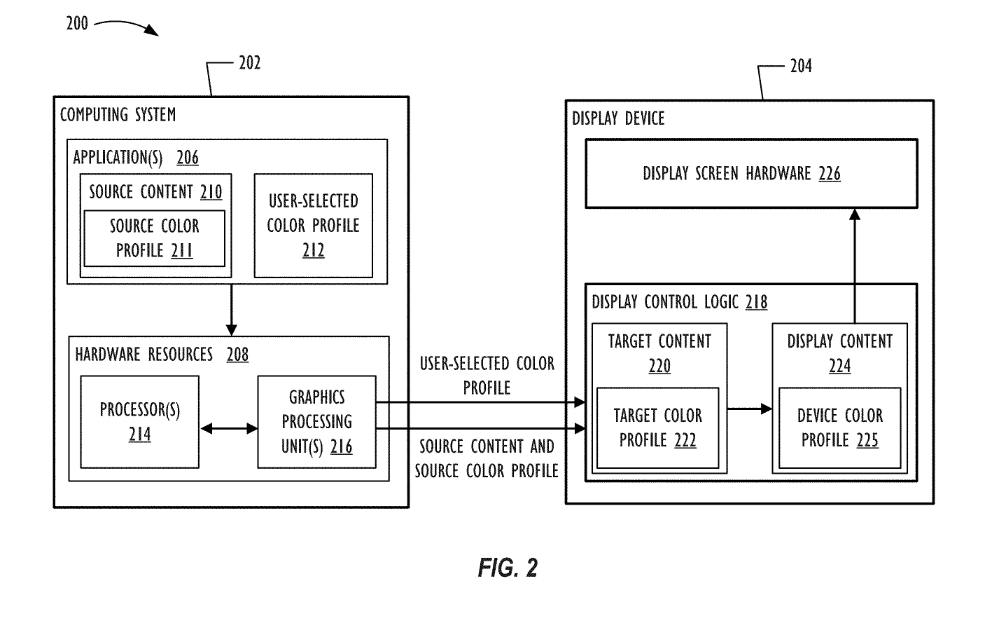

FIG. 2 is a block diagram of an embodiment of a computing system architecture 200 adapted to perform color matching based on a user-selected color profile for a display device 204. Using FIG. 1 as an example, the computing system architecture 200 may be implemented using one or more of the computing devices 106 and/or one or more of the mobile communication devices 108. FIG. 2 illustrates that the computing system architecture 200 encompasses a computing system 202 and a display device 204. The computing system 202 and the display device 204 can be implemented as separate devices that connect together using a wireless connection and/or externally wired connection that include, but is not limited to, a video graphics array (VGA) connection, a digital visual interface (DVI) connection, a high-definition multimedia interface (HDMI) connection, and/or a DisplayPort connection. In another embodiment, the display device 204 may be embedded and internally connected to the computing system 202. Examples of embedded display devices 204 include, but are not limited to, displays screens installed within mobile devices, tablet computer systems, mobile phones, and smart devices.

In FIG. 2, a user is able to select a user-selected color profile 212 to view source content 210 using one or more applications 206 on the display device 204. In particular, the user-selected color profile 212 corresponds to the color profile that a user desires to set for the display device 204. For example, one application 206 (e.g., a system preference/setting application) may include a user interface that allows a user to assign and switch between different color profiles, such as an RGB color profile and custom color profile. Stated another way, the user-selected color profile 212 are color profiles that are visible to a user and targets altering the color properties of display device 204. The user-selected color profile 212 may in some instances be compatible with the display device's 204 settings, while in other instances may be incompatible with the display device's 204 settings.

To display source content 210 on the display device 204 based on a user-selected color profile 212, applications 206 may call and provide the source content 210 to hardware resources 208 for rendering. Although not specifically shown, application 206 may utilize one or more application program interfaces (APIs) to interface with the hardware resources 208, one or more graphics framework layers, and/or operating system (O/S) services. As an example, applications 206 may issue a draw call and provide the source content 210, source color profile 211, and user-selected color profile 212 to the hardware resources 208 via an API. The hardware resources 208 (e.g., GPUs 216) may subsequently provide the user-selected color profile 212, the rendered source content, the source color profile 211, and/or other image information to the display device 204 for output.

FIG. 2 illustrates that the hardware resources 208 may include one or more processors 214 and one or more graphics processing units (GPUs) 216 to render the source content. Processors 214 may be implemented using one or more central processing units (CPUs), where each CPU may contain one or more processing cores and/or memory components that function as buffers and/or data storage (e.g., cache memory). The processors 214 may also be part of or are coupled to one or more other processing components, such as application specific integrated circuits (ASICs), field-programmable gate arrays (FPGAs), and/or digital signal processors (DSPs). The hardware resources 208 may be able to utilize processors 214, GPUs 216, or simultaneously use both the GPUs 216 and processors 214 to render the source content. Although not explicitly shown in FIG. 2, hardware resources 208 may include other types of hardware resources (e.g., memory) known by persons of ordinary skill in the art for rendering the source content 210.

As shown in FIG. 2, the display device 204 includes a display control logic 218 and display screen hardware 226 for displaying the source content 210. The display screen hardware 226 represents hardware well-known in the art (e.g., a light source and diffuser) that illuminates one or more images on the display device screen. The design and implementation of the display screen hardware 226 may differ depending on the type of display device. Non-limiting examples of display device types include liquid crystal displays, plasma displays, and light emitting diode displays (e.g., organic light emitting diode displays). In one or more embodiments, the display screen hardware 226 may be calibrated (e.g., factory calibration) to a specified setting that dictates the types of color profiles that display device 204 is compatible with.

The display control logic 218 may correspond to or be part of the color management system previously described. To implement the color management system, the display control logic 218 may include one or more processors and/or other type of system on chip (SoC) components to process the rendered source content. As an example, the display control logic 218 may include processing components, such as ASICs, FPGAs, DSPs, and memory for performing color space conversions and/or to instruct the display screen hardware 226 to display the rendered source content. In one or more embodiments, the display control logic 218 may act as a smart display that is able to perform one or more functions the processors 214 and/or GPUs 216 generally perform. Stated another way, depending on the display control logic's 218 processing capability and/or computing resources, the computing system 202 may offload one or more rendering tasks to the display control logic 218 via a connection (e.g., a Universal Serial Bus-C connection).

In FIG. 2, the display device 204 receives the user-selected color profile 212, rendered source content, and source color profile 211 from computing system 202 via at least one connection (e.g., wired or wireless connection). When the display control logic 218 receives the different color profiles 211 and 212 and rendered source content, the display control logic 218 is able to perform multiple device-dependent color space conversions to generate the display content 224 in real-time. The display control logic 218 may assign the user-selected color profile 212 as the target color profile 222. Afterwards, the display control logic 218 performs a first device-dependent color space conversion that color matches the source color profile 211 associated with the source content 210 to the target color profile 222. Based on the first device-dependent color space conversion, the display control logic 218 generates a target content 220. The display control logic 218 then performs a second device-dependent color space conversion that color matches the target color profile 222 to the device color profile 225. The second device-dependent color space conversion generates the display content 224, which is sent to the display screen hardware 226 for display.

The display control logic 218 may be configured to fix the device color profile 225 to match a specific calibration (e.g., factory calibration) setting loaded within the display control logic 218 and/or other section of the display device 204. When the display control logic 218 receives the user-selected color profile 212, the display control logic 218 sets the target color profile 222 associated with target content 220 according to the user-selected color profile 212. The user is unable to access or modify the device color profile 225 to prevent incompatibility or mismatches with the device color profile 225 and display settings of the display device 204. For example, the device color profile 225, which includes image information, such as white point, gamma and gray tracking, and primaries, correctly maps to the settings of the display device 204. By doing so, the display control logic 218 to able reproduce colors that align with a user's expectation and/or designated color schemes irrespective of the color profile set as the user-selected color profile 212.

Although FIG. 2 illustrates a specific embodiment of a computing system architecture 200, the disclosure is not limited to this specific embodiment. For example, the computing system architecture 200 may not be limited to a display device, but may also be applicable to other types of output devices (e.g., printers). Additionally, the display device 204 may not be limited to performing color management operations (e.g., color space conversions) within the display control logic 218. Instead, the display control logic 218 may communicate with other hardware, such as a dedicated chipset or utilize software (e.g., firmware) when performing color management operations. In one or more embodiments, computing system architecture 200 may have computing system 202 perform at least some of the color management operations within the computing system 202. For example, the computing system 202 may implement the color space conversion from the source color profile 211 to the target color profile 222 to generate the target content 220. The computing system architecture 200 is also not limited in having computing system 202 connect to a single display device 204 and instead could connect to multiple display devices 204 that are externally connected, internally connected, or both even though not explicitly shown in FIG. 2.

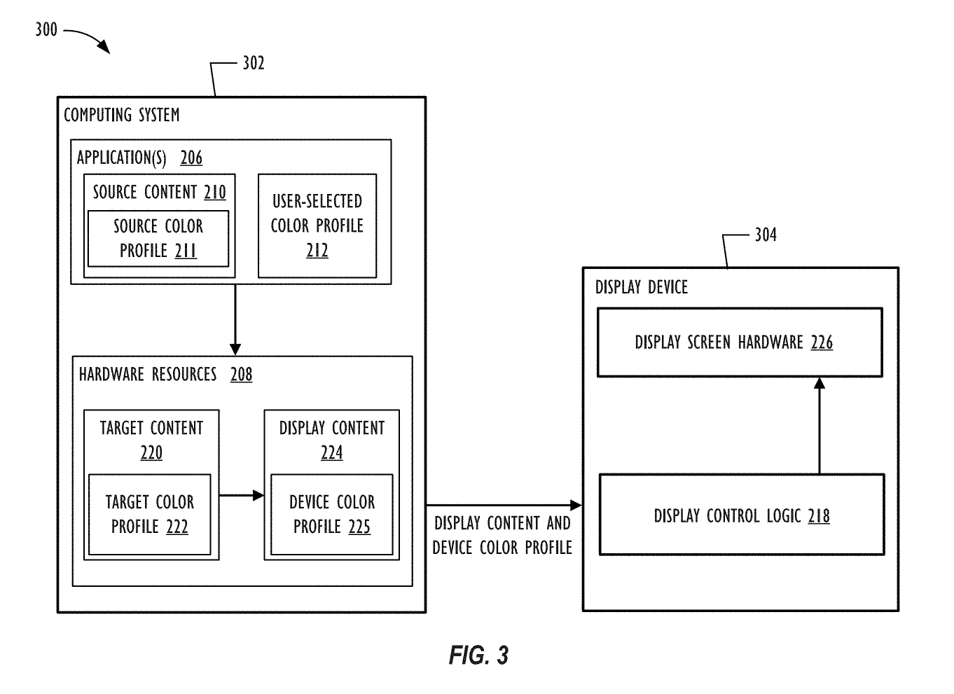

FIG. 3 is a block diagram of an embodiment of a computing system architecture 300 adapted to perform color matching operations within a computing system 302. In contrast to FIG. 2, rather than having the display device 304 perform color management operations (e.g., device-dependent color space conversions), the hardware resources 208 may be configured to perform the color management operations. Using FIG. 2 as an example, instead of the display control logic 218 generating the target content 220 and display content 224, the GPUs 216 and/or processors 214 could generate both the target content 220 and display content 224 and their associated color profiles 222 and 225, respectively. Additionally or alternatively, the computing system 302 may include a dedicated chipset, firmware, and/or software that implements and manages the color management operations. For example, the color management operations may be implemented using a dedicate application or software that is part of computing system's 302 operating system.

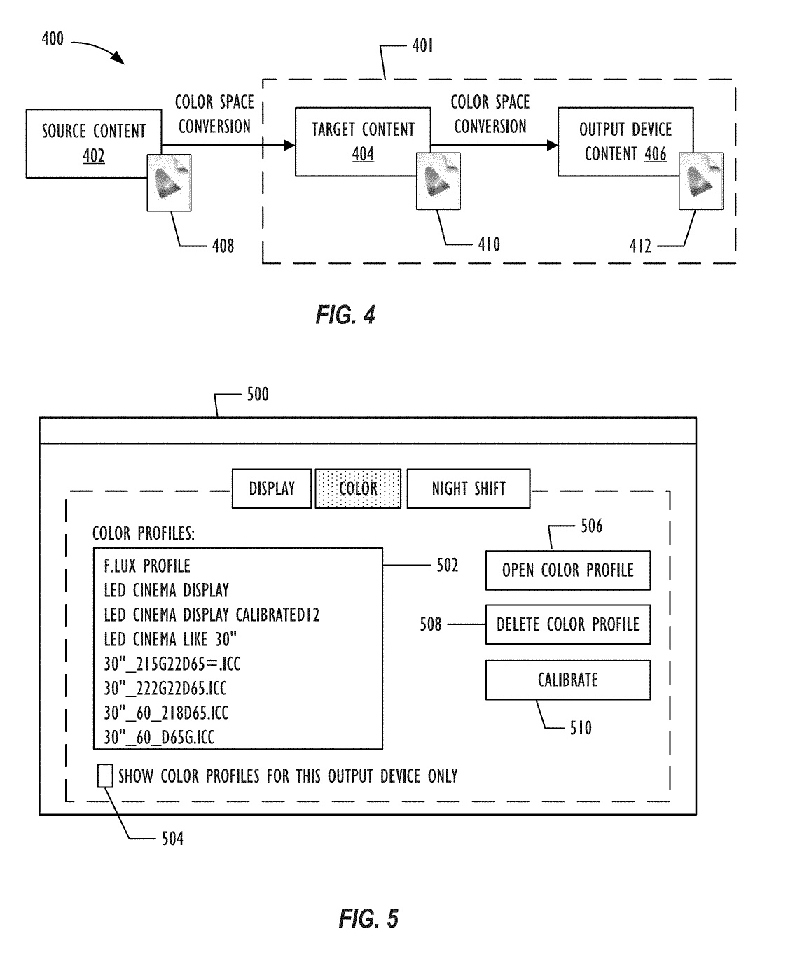

FIG. 4 illustrates an embodiment of a color matching architecture 400 that includes a color management system to color match a source color profile 408 to a device color profile 412. Using FIG. 1 as an example, the color matching architecture 400 may be implemented within one or more computing devices 106 and/or one or more mobile communication devices 108. FIG. 4 depicts an output device 401 receiving source content 402 that is associated with a source color profile 408, utilizing a target color profile 410 to generate target content 404, and utilizing a device color profile 412 to generate an output device content 406. The source color profile 408 describes characteristics of the electronic device that created the source content 402. The target color profile 410 is associated with the target content 404 and is set according to a user-selected color profile for the output device. The device color profile 410 is associated with the output device content 406 and corresponds to the characteristics of the output device 401 (e.g., display settings for a display device).

Each of the color profiles 408, 410, and 412 defines how a particular output device translates to and/or from a color space. For purposes of this disclosure the term “color model” refers to a method for describing a color, for example, using RGB elements or CMYK elements to generate certain colors in a color space, and the term “color space” is defined as a space in which the range of colors of a device are represented. In one or more embodiments, the color profiles 408, 410, and 412 may employ a numerical model that translates and/or maps color values to designated colors within the color space. Examples of various colors spaces associated with color profiles 408, 410, and 412 include, but are not limited to, variant RGB color spaces (e.g., sRGB color space), variant CMYK color space, and luminance-color spaces, such as YCrCb. Each type of color space may have multiple color channels, where each color channel represents a color or characteristic (e.g., luminance or brightness) of the color space. As an example, an RGB color space can be divided into three color channels (e.g., red, green, and blue color channels). Meanwhile, a CMYK color space may be divided into four different color channels (e.g., cyan, magenta, yellow, and black). Depending on the desired color adjustment, a color management system may use one or more channels of a given color space to obtain a desired color.

As shown in FIG. 4, the output device 401 may perform device-dependent color space conversions to color match the different color profiles 408, 410, and 412. In particular, the output device 401 performs multiple device-dependent color space conversions to produce the display content 406 while minimizing color distortions. As shown in FIG. 4, the output device 401 utilizes a target color profile 410 as an intermediate color profile to color match the source color profile 408 with the device color profile 412. To output (e.g., display) source content 402 on output device 401, the output device 401 performs a device-dependent color space conversion of the source color profile 402 to the target color profile 410. Afterwards, the output device 401 performs another device-dependent color space conversion of the target color profile 410 to a device color profile 412. Color matching between the target color profile 410 to the device color profile 412 allows the colors for a source content 402 to output correctly on the output device 401 (e.g., avoids color mismatching) even when a user selects a color profile that fails to match the settings of the output device 401.

In one or more embodiments, device-dependent color space conversion may implement multiple translation operations that utilize a device-independent color space, such as a generic profile connection space, as an intermediate color space. Device-independent color spaces define colors independent of the devices that create or output the source content 402. Often times, device-independent color spaces exceed the color ranges or gamut of device-dependent color spaces. As an example, the CIE L*a*b* (CIELAB) color space may include both the color ranges of a particular RGB color space and CMYK color space. Persons of ordinary skill in the art are aware that L*, a*, and b* represent absolute values that have pre-defined ranges. The output device 401 may use other types of a device-independent color spaces, such as the CIE XYZ (CIEXYZ) color space.

In one or more embodiments, to preserve the image quality of the source content 402, the output device 401 performs a translation operation that converts the color space associated with the source color profile 408 to a generic profile connection space, such as the CIELAB color space or CIEXYZ color space. Converting the source color profile 408 to the generic profile connection space may be beneficial when transforming and/or adjusting color space values, such as obtaining a desired color or brightness. Afterwards, the color space conversion may perform another translation operation from the generic profile connection space to the color space associated with the target color profile 410. A similar device-dependent color space conversion that utilizes a device-independent color space (e.g., generic profile connection space) may be implemented when converting the target color profile 410 to the device color profile 412. Other embodiments of color matching architecture 400 may implement other device-independent dependent color space conversions and/or translation operations that are known by persons of ordinary skill in the art.

The color matching architecture 400 allows a user to assign any color profile to the output device 401 while reducing color distortions originating from incompatibility issues between the target color profile 410 and the output device's 401 settings. Because the device color profile 412 is fixed and set to correspond to the output device's 401 settings, the color matching architecture 400 generates output device content 406 that accurately reproduces color to match a user's expectation and/or designated color schemes. The device color profile 412 is not accessible by a user, and a user is unable to change the device color profile 412. Any changes made by a user affects and/or modifies the target color profile 410. In other words, the device color profile 412 and the target color profile 410 are independent of each other, where the device color profile 412 corresponds to a representation compatible with the output device 401 and the target color profile 410 represents a user preference for the behavior of the output device 401.

FIG. 5 illustrates a user interface 500 for adjusting a target color profile that represents a user's preference for the behavior of an output device. Using FIG. 4 as an example, a user may be able to select a color profile within the user interface 500 to adjust the target color profile 410. As shown in FIG. 5, the user interface 500 includes a window 502 that lists different color profiles a user may select for an output device. The window 502 may include color profiles that are compatible with the output device, incompatible with the output device, or both. Using FIG. 5 as an example, the f.lux profile may be a color profile that is compatible with the output device, but the LED Cinema Display profile may be incompatible. When a user selects one of the listed color profiles within window 502, the color management system assigns the user-selected color profile as the target color profile. The user interface 500 does not provide color profiles for device color profile 412 as the color profile is not accessible to the user.

The user interface 500 may also include a variety of options for adjusting, viewing, or filtering out certain color profiles. As shown in FIG. 5, the user interface 500 includes a “show color profiles for this display device only” option 504 that acts as a color profile matching option to filter out incompatible color profiles for the output device. When a user checks or selects the boxed area for the “show color profiles for this display device only” option 504, the user interface 500 removes incompatible color profiles for the output device from window 502. Conversely, if the user unchecks the box or leaves the boxed area unselected, window 502 may include incompatible color profiles. In one or more embodiments, the “show color profiles for this display device only” option 504 may be removed from the user interface 500 when using target color profile to represent a user's preference for the behavior of the display device, such as the target color profile 410 shown in FIG. 4. User interface 500 also includes a variety of options, such as the “open color profile” option 506, “delete color profile” option 508, and the “calibrate” option 510 that allow a user to view a color profile in more detail, remove a color profile, or modify a color profile, respectively.

In one or more embodiments, the user interface 500 may allow a user to simulate any arbitrary display device or other output device when implementing computing system and color matching architectures as described in FIGS. 2-4. By utilizing the color profiles available within window 502, when a user selects a color profile from the window 502, the output device may generate a simulated display device or other output device compatible with the user-selected color profile. As discussed in FIGS. 2-4, the user-selected color profile becomes the target color profile. Based on the user's selection, the colors displayed on the output device may correspond to or simulate what would appear for an arbitrary display device or other output device. For example, utilization of the target color profile in essence can create a color soft-proofing function that simulates on the output device (e.g., display device), color printing on a printing device by assigning a printer profile to a target color profile. Being able to simulate any arbitrary output device functionality may be useful in a variety of image producing fields, such as graphic designs, digital photography, and cinema.

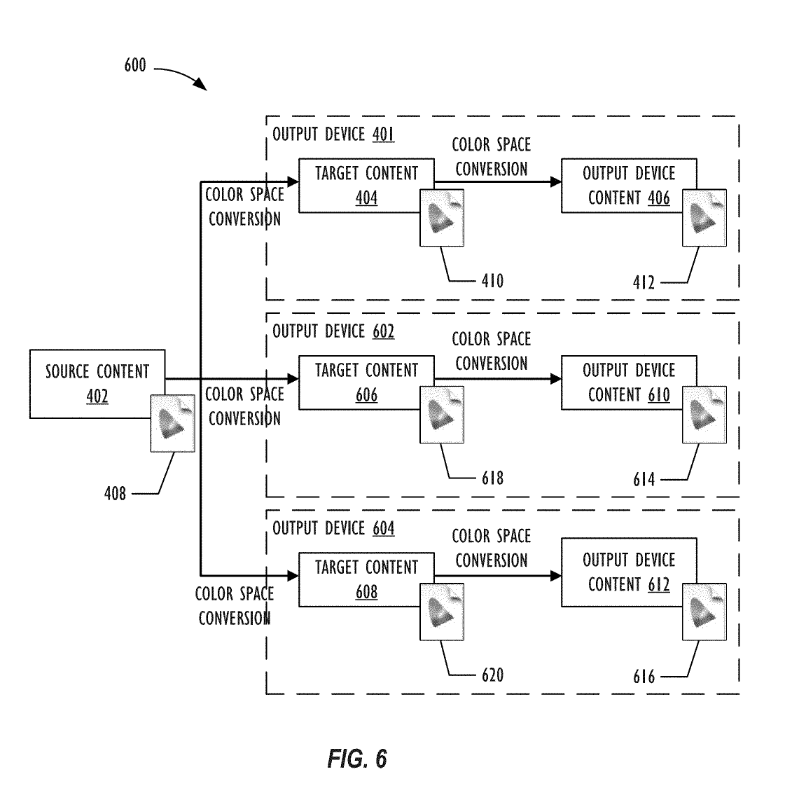

FIG. 6 illustrates an embodiment of color matching architecture 600 that color matches a source color profile 408 to multiple device color profiles 412, 614, and 616. The color matching architecture 600 is similar to the color matching architecture 400 shown in FIG. 4 except that the color matching may simultaneously be implemented over multiple output devices. For instance, the color matching architecture 600 may independently perform multiple device-dependent color space conversions as described for the color matching architecture 400. The color matching architecture 600 also assigns user-selected color profiles as target color profiles 410, 618, and 620 and does not alter the device color profiles 412, 614, and 616.

In FIG. 6, a single source content 402 may be output to output device 401, output device 602, and output device 604. Each output device 401, 602, and 604 may be a display device, printer, and/or any other device that outputs colored, digital content. FIG. 6 also illustrates that each output device 401, 602, and 604 may produce its own target content 404, 606, 608 that are associated with target color profiles 410, 618, and 620, respectively, and output device content 406, 610, and 612 that are associated with device color profiles 412, 614, and 616, respectively. The device color profiles 412, 614, and 616 may differ from each other since the device color profiles 412, 614, and 616 are dependent on device settings and calibration for output devices 401, 602, and 604.

In one embodiment, a user may independently select each of the target color profiles 410, 618, and 620 using multiple user-selected color profiles to generate target contents 404, 606, and 608. The color matching architecture 600 may employ a user interface, such as user interface 500 shown in FIG. 5 that allows a user to independently select three different color profiles and set the different user-selected color profiles as target color profiles 410, 618, and 620. Using FIG. 5 as an example, a user may independently select the f.lux profile as target color profile 410, LED Cinema Display profile as target color profile 618, and 30″_222G22D65.ICC profile as target color profile 620. Alternatively, the color matching architecture 600 may also configure the user interface to allow a user to independently select the same color for at least two of the target color profiles 410, 618, and 620. For example, a user may independently select the f.lux profile for both the target color profile 410 and 618 and 30″_222G22D65.ICC profile as target color profile 620. Other embodiments of the color matching architecture 600 may have two or more of the target color profiles 410, 618, and 620 be dependent on a single a user-selected color profile. As an example, a user may provide a single selection that indicates the f.lux profile is the user-selected color profile. Based on the user's single selection, the f-lux profile is then set as the target color profile 410, 618, and 620.

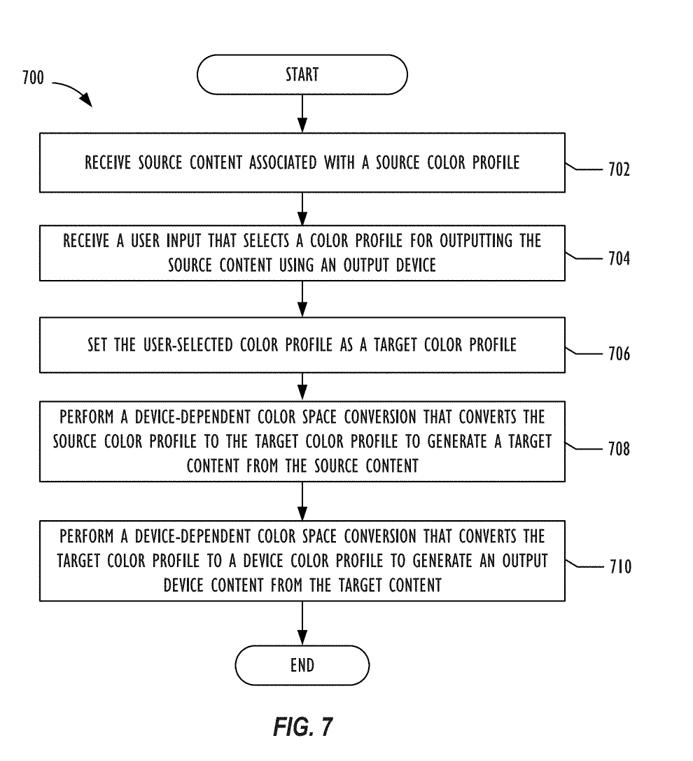

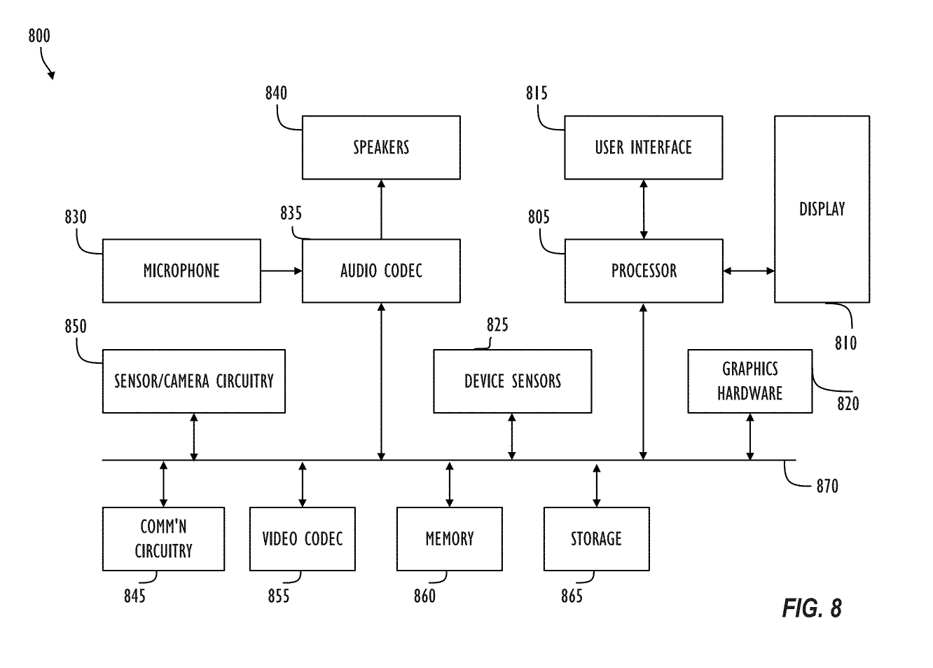

FIG. 7 depicts a flowchart illustrating a color matching operation 700 between a source color profile and a user-selected color profile. In one embodiment, operation 700 may be implemented within any of the computing system architectures 200 and 300 and/or any of the color matching architectures 400 and 600 shown in FIGS. 2-4 and 6. Although FIG. 7 illustrates that the blocks within operation 700 are implemented in a sequential order, operation 700 is not limited to this sequential order. For instance, one or more of the blocks, such as blocks 702 and 704, could be implemented in parallel operations. The use and discussion of FIG. 7 is only an example to facilitate explanation and is not intended to limit the disclosure to this specific example.

Operation 700 may start at block 702 receive source content associated with a source color profile. In one or more embodiments, operation 700 may receive the source content from an image capture device such as a camera or as a data file from a remote device. The image capture device may be coupled to or be part of the device that also performs the color matching operations. At block 704, operation 700 may receive a user input that selects a color profile to output the source content using an output device. The selected color profile is indicative of a user's preference for the behavior of the output device. Operation 700 may then move to block 706 and set the user-selected color profile as a target color profile. The target color profile acts as an intermediate color profile between the source color profile and the device color profile. The target color profile may be changed according the user's input. The target color profile and/or user selection does not affect and are independent of a device color profile for the output device.

Operation 700 may then move to block 708 and perform a device-dependent color space conversion that converts the source color profile to the target color profile to generate target content from the source content. Recall with reference to FIG. 4, the device-dependent color space conversion may include multiple translation operations that convert the color space of the source color profile to a device-independent color space, and then to the color space of the target color profile. Operation 700 then moves to block 710 and performs a device-dependent color space conversion that converts the target color profile to a device color profile to generate output device content from the target content. Similar to block 708, multiple translation operations may be performed in accordance with block 710. Afterwards, operation may end.

Referring to FIG. 800, a simplified functional block diagram of illustrative device 800 that color matches as described in FIGS. 2, 3, 4, and 6. Device 800 may include processor 805, display 810, user interface 815, graphics hardware 820, device sensors 825 (e.g., proximity sensor/ambient light sensor, accelerometer and/or gyroscope), microphone 830, audio codec(s) 835, speaker(s) 840, communications circuitry 845, sensor and camera circuitry 850, video codec(s) 855, memory 860, storage 865, and communications bus 870. Electronic device 800 may be, for example, a digital camera, a personal digital assistant (PDA), personal music player, mobile telephone, server, notebook, laptop, desktop, or tablet computer. More particularly, the disclosed techniques may be executed on a device that includes some or all of the components of device 800.

Processor 805 may execute instructions necessary to carry out or control the operation of many functions performed by a multi-functional electronic device 800 (e.g., such as color matching). Processor 805 may, for instance, drive display 810 and receive user input from user interface 815. User interface 815 can take a variety of forms, such as a button, keypad, dial, a click wheel, keyboard, display screen and/or a touch screen. Processor 805 may be a system-on-chip such as those found in mobile devices and include a dedicated graphics-processing unit (GPU). Processor 805 may represent multiple central processing units (CPUs) and may be based on reduced instruction-set computer (RISC) or complex instruction-set computer (CISC) architectures or any other suitable architecture and each may include one or more processing cores. Graphics hardware 820 may be special purpose computational hardware for processing graphics and/or assisting processor 805 process graphics information. In one embodiment, graphics hardware 820 may include one or more programmable graphics-processing unit (GPU), where each such unit has multiple cores.

Sensor and camera circuitry 850 may capture still and video images that may be processed to generate images in accordance with this disclosure. Sensor in sensor and camera circuitry 850 may capture raw image data as red, green, and blue (RGB) data that is processed to generate an image. Output from camera circuitry 850 may be processed, at least in part, by video codec(s) 855 and/or processor 805 and/or graphics hardware 820, and/or a dedicated image-processing unit incorporated within camera circuitry 850. Images so captured may be stored in memory 860 and/or storage 865. Memory 860 may include one or more different types of media used by processor 805, graphics hardware 820, and camera circuitry 850 to perform device functions. For example, memory 860 may include memory cache, read-only memory (ROM), and/or random access memory (RAM). Storage 865 may store media (e.g., audio, image and video files), computer program instructions or software, preference information, device profile information, and any other suitable data. Storage 865 may include one more non-transitory storage mediums including, for example, magnetic disks (fixed, floppy, and removable) and tape, optical media such as compact disc-ROMs (CD-ROMs) and digital video disks (DVDs), and semiconductor memory devices such as Electrically Programmable Read-Only Memory (EPROM), and Electrically Erasable Programmable Read-Only Memory (EEPROM). Memory 860 and storage 865 may be used to retain computer program instructions or code organized into one or more modules and written in any desired computer programming language. When executed by, for example, processor 805 such computer program code may implement one or more of the methods described herein.

As used herein, the term “computer system” or “computing system” refers to a single electronic computing device or to two or more electronic devices working together to perform the function described as being performed on or by the computing system. This includes, by way of example, a single laptop, host computer system, wearable electronic device, and/or mobile device (e.g., smartphone, tablet, and/or other smart device).

It is to be understood that the above description is intended to be illustrative, and not restrictive. The material has been presented to enable any person skilled in the art to make and use the claimed subject matter as described herein, and is provided in the context of particular embodiments, variations of which will be readily apparent to those skilled in the art (e.g., some of the disclosed embodiments may be used in combination with each other). For example, while FIG. 2 has been described in the context of color matching within a display device, color matching is not limited to a display device, but instead can involve other output devices. In addition, some of the described operations may have their individual steps performed in an order different from, or in conjunction with other steps, than presented herein. More generally, if there is hardware support some operations described in conjunction with FIG. 7 may be performed in parallel.

At least one embodiment is disclosed and variations, combinations, and/or modifications of the embodiment(s) and/or features of the embodiment(s) made by a person having ordinary skill in the art are within the scope of the disclosure. Alternative embodiments that result from combining, integrating, and/or omitting features of the embodiment(s) are also within the scope of the disclosure. Where numerical ranges or limitations are expressly stated, such express ranges or limitations may be understood to include iterative ranges or limitations of like magnitude falling within the expressly stated ranges or limitations (e.g., from about 1 to about 10 includes, 2, 3, 4, etc.; greater than 0.10 includes 0.11, 0.12, 0.13, etc.). The use of the term “about” means±10% of the subsequent number, unless otherwise stated.

Many other embodiments will be apparent to those of skill in the art upon reviewing the above description. The scope of the invention therefore should be determined with reference to the appended claims, along with the full scope of equivalents to which such claims are entitled. In the appended claims, the terms “including” and “in which” are used as the plain-English equivalents of the respective terms “comprising” and “wherein.”

1. A non-transitory program storage device, readable by one or more programmable control devices and comprising instructions stored thereon to cause the one or more programmable control devices to:
receive a user input to select a color profile to output a source content to an output device, wherein the source content is associated with a source color profile that maps a first set of color values to a first color space;
set the selected color profile as a target color profile, wherein the target color profile is a device-dependent target color profile that maps a second set of color values to a second color space;
perform a first device-dependent color space conversion that converts the source color profile to the device-dependent target color profile via at least one device-independent color space;
generate a target content from the source content based on the conversion of the source color profile to the device-dependent target color profile;
perform a second device-dependent color space conversion that converts the device-dependent target color profile to a device color profile via at least one device-independent color space, wherein the device color profile maps a third set of color values to a third color space; and
generate an output device content from the target content based on the conversion of the device-dependent target color profile to the device color profile.

2. The non-transitory program storage device of claim 1, wherein the target color profile and device color profile are managed within the output device.

3. The non-transitory program storage device of claim 1, wherein the device color profile is a fixed calibration that is not affected by the user input to select the color profile.

4. The non-transitory program storage device of claim 1, wherein the device color profile is independent of the target color profile.

5. The non-transitory program storage device of claim 1, wherein the instructions to perform a first device-dependent color space conversion comprise instructions that cause the one or more programmable control devices to:
perform a first translation operation that converts the first color space of the source color profile to the at least one device-independent color space; and
perform a second translation operation that converts the at least one device-independent color space to the second color space.

6. The non-transitory program storage device of claim 5, wherein the at least one device-independent color space is a generic profile connection space.

7. The non-transitory program storage device of claim 1, wherein the device color profile is not visible via a user interface.

8. The non-transitory program storage device of claim 1, wherein the first device-dependent color space conversion is performed within a graphics processing unit.

9. A system comprising:
memory; and
one or more programmable control devices operable to interact with the memory, and to perform operations comprising:
obtaining a source content associated with a source color profile that maps a first set of color values to a first color space;
receiving instructions to select a color profile for an output device;
setting the selected color profile as a target color profile, wherein the target color profile is a device-dependent target color profile that maps a second set of color values to a second color space;
performing a first device-dependent color space conversion that converts the source color profile to the device-dependent target color profile via at least one device-independent color space;
generating a target content from the source content based on the conversion of the source color profile to the device-dependent target color profile;
performing a second device-dependent color space conversion that converts the device-dependent target color profile to a device color profile via at least one device-independent color space, wherein the device color profile maps a third set of color values to a third color space; and
generating an output device content from the target content based on the conversion of the device-dependent target color profile to the device color profile.

10. The system of claim 9, wherein the device color profile is a fixed calibration that is not affected by the instructions to select the color profile.

11. The system of claim 9, wherein the device color profile is independent of the target color profile.

12. The system of claim 9, wherein performing a first device-dependent color space conversion comprises performing operations comprising:
performing a first translation operation that converts the first color space of the source color profile to the at least one device-independent color space; and
performing a second translation operation that converts the at least one device-independent color space to the second color space.

13. The system of claim 12, wherein the at least one device-independent color space is a generic profile connection space.

14. The system of claim 9, wherein the first device-dependent color space conversion is performed within a graphics processing unit.

15. A computer-implemented method comprising:
obtaining a source content associated with a source color profile that maps a first set of color values to a first color space;
receiving instructions to select a color profile for an output device;
setting the selected color profile as a target color profile, wherein the target color profile is a device-dependent target color profile that maps a second set of color values to a second color space;
performing a first device-dependent color space conversion that converts the source color profile to the device-dependent target color profile via at least one device-independent color space;
generating a target content from the source content based on the conversion of the source color profile to the device-dependent target color profile;
performing a second device-dependent color space conversion that converts the device-dependent target color profile to a device color profile via at least one device-independent color space, wherein the device color profile maps a third set of color values to a third color space; and
generating an output device content from the target content based on the conversion of the device-dependent target color profile to the device color profile.

16. The method of claim 15, wherein the target color profile and device color profile are managed within the output device.

17. The method of claim 15, wherein the device color profile is a fixed calibration that is not affected by the instructions to select the color profile.

18. The method of claim 17, wherein performing a first device-dependent color space conversion comprises:
performing a first translation operation that converts the first color space of the source color profile to the at least one device-independent color space; and
performing a second translation operation that converts the at least one device-independent color space to the second color space.

19. The method of claim 18, wherein the at least one device-independent color space is a generic profile connection space.

20. The method of claim 17, wherein the first device-dependent color space conversion is performed within a graphics processing unit.
